(19) United States
(12) Patent Application Publication
(10) Pub. No.: US 2022/0079171 A1
(43) Pub. Date: Mar. 17, 2022

(54) PROCESSES FOR MAKING THIN SNACK FOODS HAVING PRETZEL-LIKE CHARACTERISTICS

(71) Applicant: Snack Connection LLC, Wilmington, DE (US)

(72) Inventors: Sara Wilson, Princeton, NJ (US); Warren Wilson, SR., Princeton, NJ (US); Warren Wilson, JR., Princeton, NJ (US)

(21) Appl. No.: 17/243,042

(22) Filed: Apr. 28, 2021

Related U.S. Application Data
(60) Provisional application No. 63/018,350, filed on Apr. 30, 2020.

(51) Int. Cl. A21D 8/02; A21D 13/40; A21D 6/00

(52) U.S. Cl. CPC A21D 8/02; A21D 6/00; A21D 13/40

(57) ABSTRACT

Processes are provided for making a snack food in the form of a thin, crisp pretzel cracker having pretzel-like characteristics. The processes incorporate a sheeted dough process with pretzel cooking and baking. The processes include reducing dough thickness through multiple gauging stations to form a thin sheet of dough, which is cut into a desired shape, submerged in a bath of caustic soda such as sodium hydroxide and water, and baked to a crispy finish by way of a multi-phase baking process.

### CROSS REFERENCE TO RELATED APPLICATIONS

This application claims the benefit under 35 U.S.C. 119(e) of U.S. Provisional Application No. 63/018,350, filed Apr. 30, 2020, the contents of which are incorporated by reference herein in their entirety.

### BACKGROUND

Pretzels are a popular snack food with a unique and iconic taste enjoyed throughout the world. Pretzels come in a large variety of shapes and sizes. A pretzel is made of dough, which can be shaped using many different techniques. For example, pretzel dough can be shaped using automated equipment such as dough extruders and dough depositors; alternatively, pretzel dough can be rolled and twisted by hand.

The pretzel dough is immersed in a caustic soda bath prior to baking. The soda bath typically is a made up of a small percentage of sodium hydroxide, and water. This step is a defining characteristic of pretzel making, and is considered essential to give the finished product the combination of pH, color, and taste unique to pretzels. The saturated dough is then seasoned, and baked at a desired temperature to produce either a soft or crunchy texture.

Crackers and baked chips typically have a flat shape profile and a crispy texture in comparison to some pretzels. A conventional cracker manufacturing process begins with rolling dough in an automated sheeter to produce a relatively thin dough sheet. The dough sheet is run through a series of rollers that progressively reduce the thickness of the sheet to a desired final value. At this stage, certain crackers require an optional lamination step where the dough sheets are layered to develop a tender, flaky texture in the finished product. If the lamination step is omitted, the final product will have more chip-style qualities. Individual dough pieces are cut out of the sheet in desired shapes, using a rolling die cutter. The dough pieces are baked at a desired temperature to produce the finished cracker product.

Crackers are subject to a phenomenon called “checking.” Checking is caused by small cracks that can form in a cracker up to several days after it is baked. The cracks are believed to result from, for example, gradients in the moisture content within the relatively thin cracker. The cracks can result in undesirable breakage of the crackers when the crackers are subjected to even minimal force.

Substantial challenges exist in making a thin snack food having the unique taste and color of a pretzel, and the crispiness normally associated with a thin cracker or chip. For example, the pretzel dough exiting the caustic soda bath is relatively sticky, making it difficult to transfer and otherwise handle thin sheets of the pretzel dough during subsequent processing operations. Also, the thin and delicate pretzel dough is easily burned during the baking process, and it can be difficult to provide the finished product with satisfactory resistance to checking. Thus, a long-felt but unfilled need currently exists for a thin foodstuff that combines the iconic taste and appearance of the pretzel with the crispiness of a cracker or chip.

### SUMMARY

In general, the disclosed technology relates to processes for making a snack food in the form of a thin, crisp pretzel cracker having pretzel-like characteristics. The processes incorporate a sheeted dough process with pretzel cooking and baking. The processes include reducing dough thickness through multiple gauging stations to form a thin sheet of dough, which is cut into a desired shape, submerged in a bath of caustic soda such as sodium hydroxide and water, and baked to a crispy finish by way of a multi-phase baking process.

In one aspect of the disclosed technology, the processes include providing dough; forming the dough into a sheet; reducing a thickness of the dough sheet; cutting the dough sheet to form dough pieces; immersing the dough pieces in a caustic soda bath; and baking the dough pieces.

In another aspect of the disclosed technology, baking the pieces of dough includes baking the pieces of dough in a multi-phase baking operation.

In another aspect of the disclosed technology, baking the pieces of dough includes baking the pieces of dough in multiple baking zones of an oven.

In another aspect of the disclosed technology, baking the pieces of dough further includes baking the pieces of dough at a temperature range of about 400° F. to about 700° F., for about 30 seconds to about 300 seconds; and subsequently baking the pieces of dough at a temperature range of about 400° F. to about 700° F., for about 30 seconds to about 300 seconds.

In another aspect of the disclosed technology, baking the pieces of dough at a temperature range of about 400° F. to about 700° F., for about 30 seconds to about 300 seconds includes baking the pieces in a first baking zone of an oven; and subsequently baking the pieces of dough at a temperature range of about 400° F. to about 700° F., for about 30 seconds to about 300 seconds includes baking the pieces in a second baking zone of the oven.

In another aspect of the disclosed technology, forming the dough into a sheet includes passing the dough through a dough sheeter.

In another aspect of the disclosed technology, reducing a thickness of the dough includes rolling the dough.

In another aspect of the disclosed technology, reducing a thickness of the dough sheet includes passing the dough sheet through one or more gauging stations.

In another aspect of the disclosed technology, reducing a thickness of the dough includes reducing the thickness of the dough to about 0.5 mm (about 0.020 inch) to about 3.0 mm (about 0.12 inch).

In another aspect of the disclosed technology, the process further includes drying the baked dough pieces.

In another aspect of the disclosed technology, drying the baked dough pieces includes heating the baked dough pieces at a temperature range of about 200° F. to about 500° F. for about 2 minutes to about 20 minutes.

In another aspect of the disclosed technology, the caustic soda bath includes sodium hydroxide and water.

In another aspect of the disclosed technology, the concentration of the sodium hydroxide is about 0.4 percent to about 2.0 percent; the temperature of the caustic soda bath is above 70° F.; and immersing the dough pieces in a caustic soda bath includes immersing the dough pieces for about 20 seconds.

In another aspect of the disclosed technology, providing dough includes providing dough formed from one of a blend of wheat flour; rice flour; potato flour; potato flakes; cassava flour; oat flour; corn masa; other vegetable flours; and any mixtures thereof.

In another aspect of the disclosed technology, reducing a thickness of the dough includes rolling the dough to a thickness of about 0.5 mm (about 0.020 inch) to about 3.0 mm (about 0.12 inch).

In another aspect of the disclosed technology, the inventive concepts relate to foodstuffs produced in accordance with the above processes.

In another aspect of the disclosed technology, the inventive concepts relate to systems for making a thin foodstuff having pretzel-like qualities. The systems include a sheeter configured to shape dough into a sheet of dough; one or more gauging stations operatively coupled to the sheeter and configured to reduce a thickness of the sheet of dough; and a die cutter operatively coupled to the one or more gauging stations and configured to cut pieces of dough from the sheet of dough. The systems further include a pretzel cooker operatively coupled to the die cutter and configured to immerse the pieces of dough in a bath of caustic soda; and a multi-zone oven operatively coupled to the pretzel cooker and configured to bake the pieces of dough in a multi-phase baking operation, and further configured to dry the baked pieces of dough.

In another aspect of the disclosed technology, the pretzel cooker is configured to immerse the pieces of dough in a bath of sodium hydroxide and water at a temperature above 70° F.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a flow diagram of a process for making a thin snack food in the form of a pretzel chip having pretzel-like characteristics.

FIG. 2 is a front perspective view of a sheeter of an exemplary system used to perform the process depicted in FIG. 1.

FIGS. 3 and 4 are front perspectives view of three gauging stations of the system shown in part in FIG. 2.

FIG. 5 is a rear perspective view of a rotary die cutter of the system shown in part in FIGS. 2-4, depicting dough pieces formed in the die cutter being conveyed from the die cutter.

FIG. 6 is a perspective view of a cutter of the rotary die cutter shown in FIG. 5.

FIG. 7 is a side view of a pretzel cooker of the system shown in part in FIGS. 2-6.

FIG. 8 is a front perspective view of a multi-zone oven of the system shown in part in FIGS. 2-7.

FIG. 9 is a rear view of the oven shown in FIG. 8, depicting the dough pieces being conveyed out of the oven.

FIG. 10 is a partial side view of the oven shown in FIGS. 8 and 9, with a side panel of the oven removed for illustrative purposes.

FIG. 11 is a magnified view of the area designated “A” in FIG. 10.

FIG. 12 is a perspective view of a pretzel chip formed in accordance with the process depicted in FIG. 1, using the system shown in FIGS. 2-11.

FIG. 13 is a perspective view of the pretzel chip shown in FIG. 12.

### DETAILED DESCRIPTION OF THE INVENTION

The following discussion omits or only briefly describes conventional features of the disclosed technology that are apparent to those skilled in the art. It is noted that various embodiments are described in detail with reference to the drawings, in which like reference numerals represent like parts and assemblies throughout the several views. Reference to various embodiments does not limit the scope of the claims appended hereto. Additionally, any examples set forth in this specification are intended to be non-limiting and merely set forth some of the many possible embodiments for the appended claims. Further, particular features described herein can be used in combination with other described features in each of the various possible combinations and permutations.

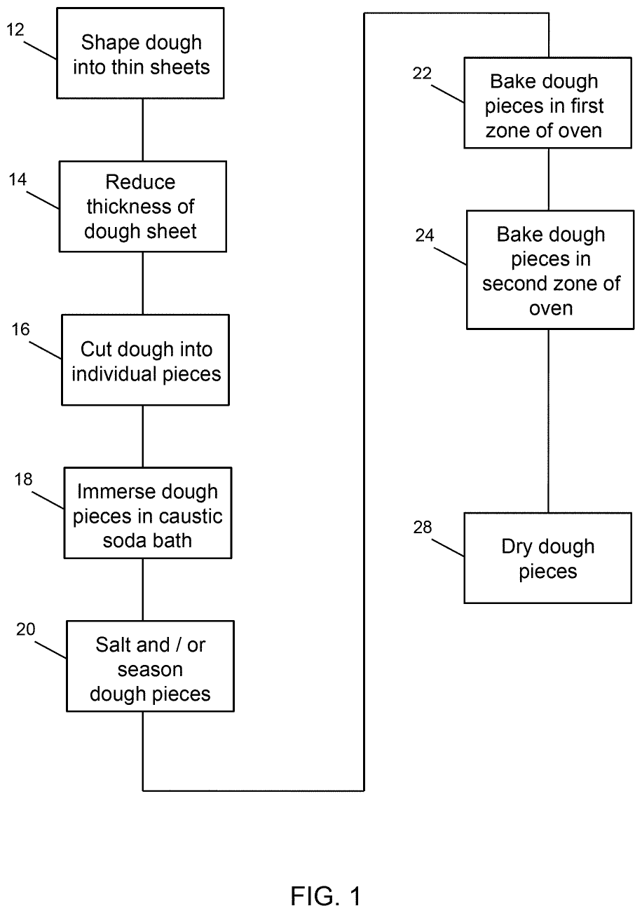

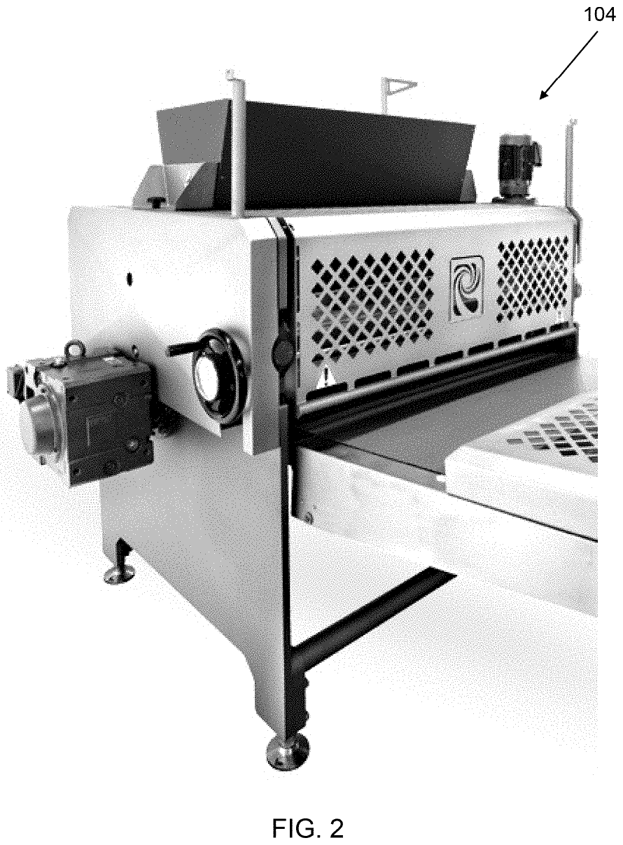

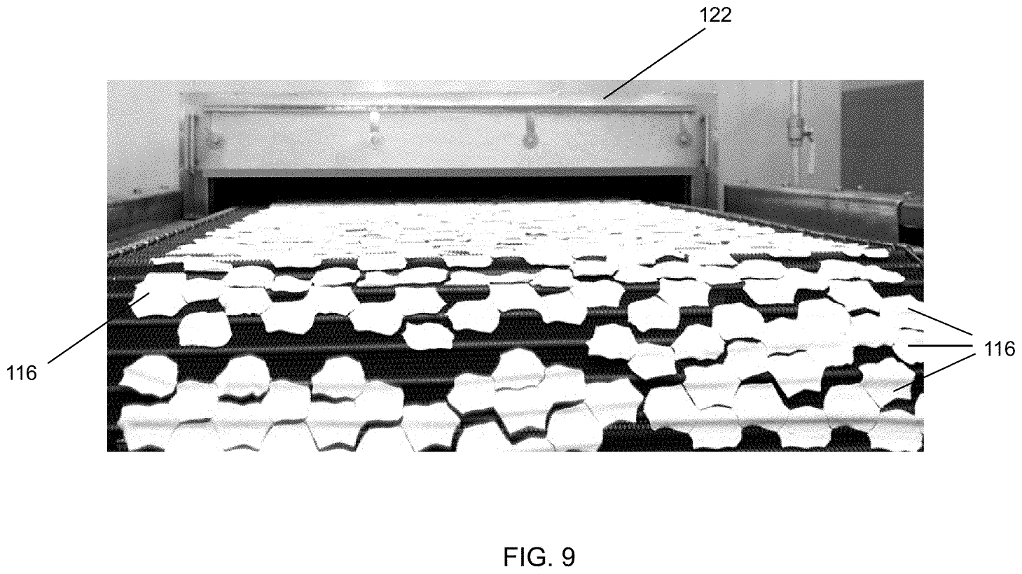

FIG. 1 illustrates a process 10 for making a thin, crisp snack food in the form of a pretzel chip 100 having pretzel-like characteristics. FIGS. 2-11 depict an exemplary system that can be used to perform the process 10.

The process 10 is performed on pretzel dough that can be produced in a conventional manner. The dough can be formed, for example, from a blend of wheat flours. Alternatively, the dough can be formed from one or more other types of flours, such as potato flour, cassava flour, oat flour, etc. The dough also can be formed from cookie dough, and from other foodstuffs. The dough can be produced in a dough extruder (not shown), or by other suitable means.

Referring to FIG. 1, the dough is reduced to create a thin sheet (step 12). For example, the dough can be processed in a three-roll dough sheeter 104, shown in FIG. 2, that forms the dough into a hole-free sheet having a substantially uniform dough density over its entire area. The sheet can have a width of about 1.2 meters (about 47 inches); alternatively, the sheet can have a width greater than, or less than 1.2 meters. In alternative versions of process 10, the dough can be formed into a sheet by a means other than the three-roll dough sheeter 104; for example, the dough can be formed into a sheet using an accompanying dough laminator, or alternatively, a dough press.

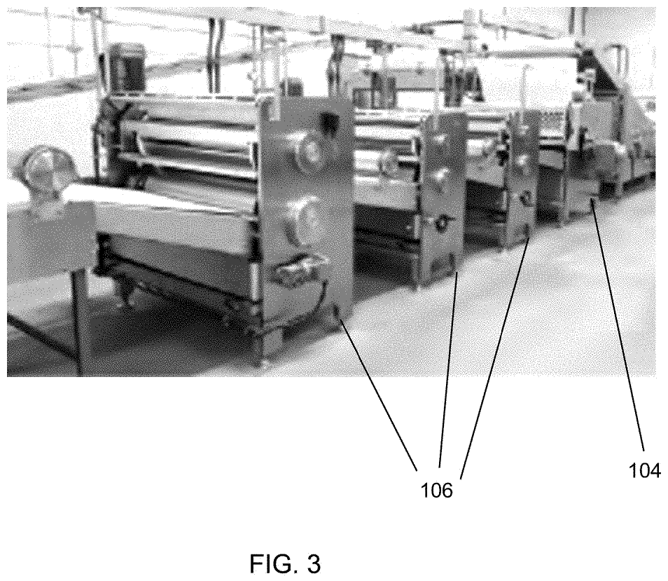

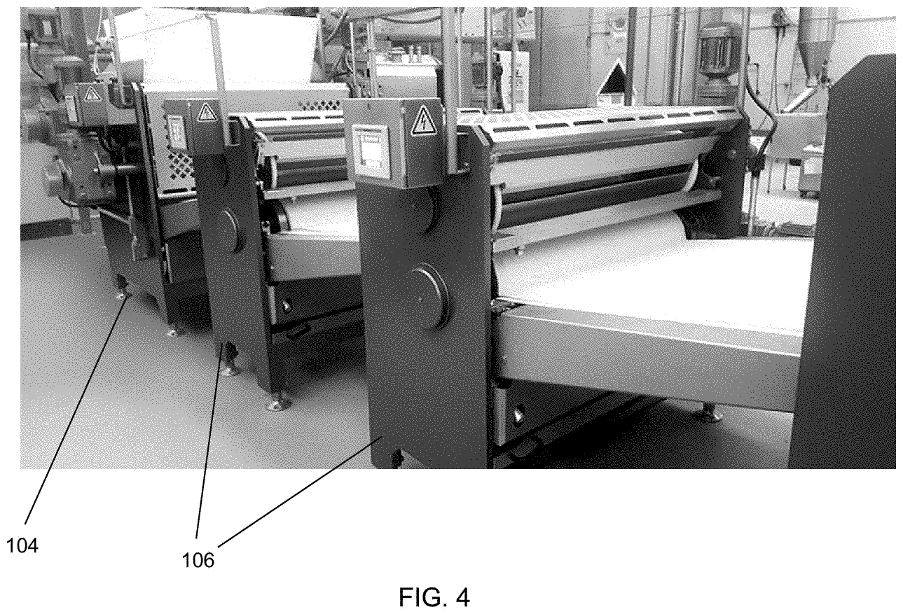

Upon exiting the sheeter 104, the dough sheet is fed through three gauging stations 106, shown in FIGS. 3 and 4, that progressively and gradually reduce the thickness of the sheet to its final values (step 14). For example, upon exiting the final gauging station 106, the thickness of the dough sheet can be about 0.5 mm to about 3.0 mm (about 0.020 inch to about 0.12 inch); and more preferably, about 0.6 mm (about 0.024 inch). The dough can be reduced in less, or more than three gauging stations 106 in alternative versions of the process 10, depending on the desired final thickness of the dough sheet.

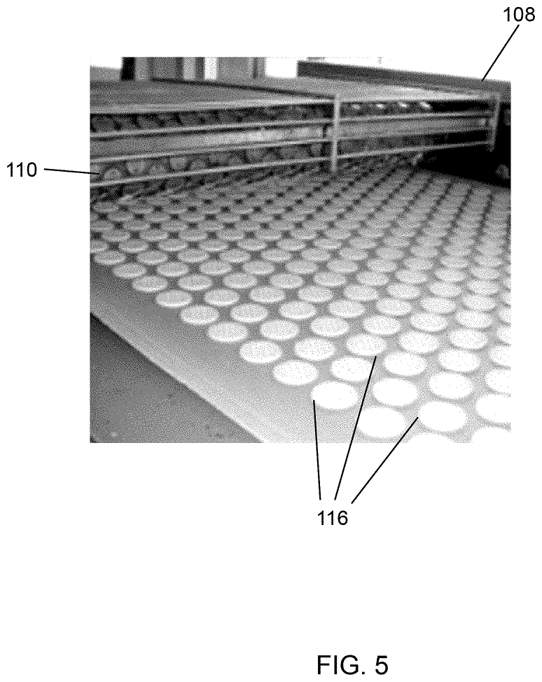

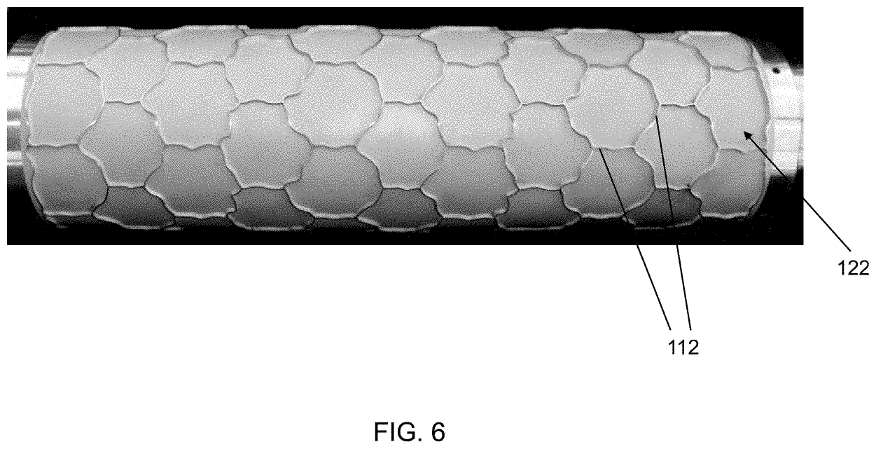

The thin dough sheet is fed into a rotary die cutter 108, shown in FIG. 5. The die cutter 108 cuts the dough sheet into individual dough pieces 116 having a desired shape (step 16). The roller 110 of the die cutter 108 can be equipped with scrapless cutters 112, depicted in FIG. 6, that form interlocking geometric dough pieces 116. The dough pieces 116 can be formed in other shapes, such as the circular shapes shown in FIG. 5, in alternative versions of the process 10. Also, the dough pieces 116 can be cut using equipment other than the rotary die cutter 108.

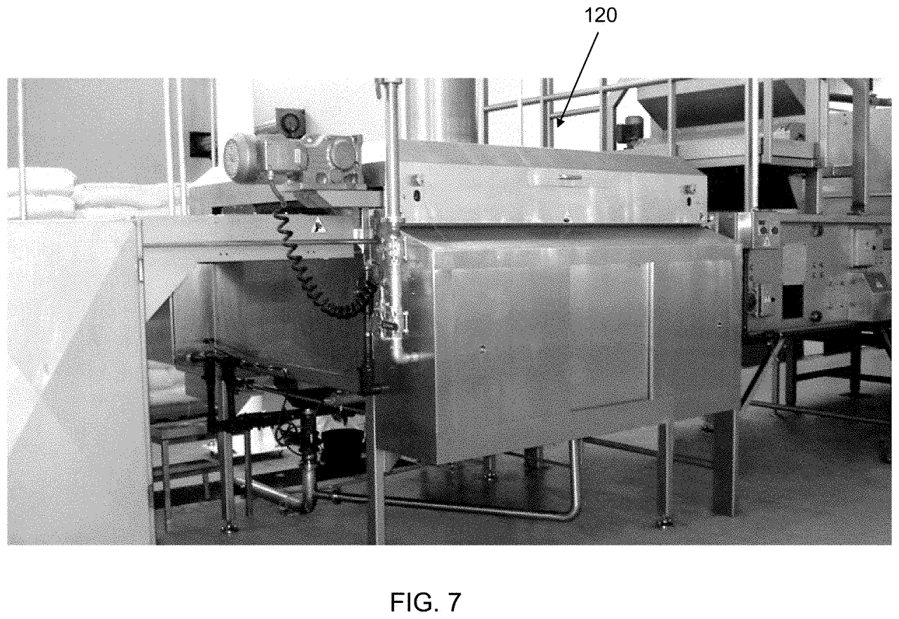

The dough pieces 116 are conveyed to a pretzel cooker 120, where the pieces 116 are immersed in a bath of caustic soda (step 18). The pretzel cooker 120 is depicted in FIG. 7. The caustic soda can be, for example, a mixture of sodium hydroxide and water. The concentration of sodium hydroxide can be, for example, about 0.4 percent to about 2.0 percent, and more preferably, about 1.0 percent. The caustic soda can be maintained at a temperature of, for example, above 70° F. The dough pieces 116 are immersed in the caustic soda for a time period of, for example, about 20 seconds, so that the dough pieces 116 have a consistent texture, pH and color; and develop a traditional pretzel flavor profile.

The cooked dough pieces 116 can be salted and seasoned as desired (step 20). The salting and seasoning operation can take place in a salter or a topping dispenser (not shown).

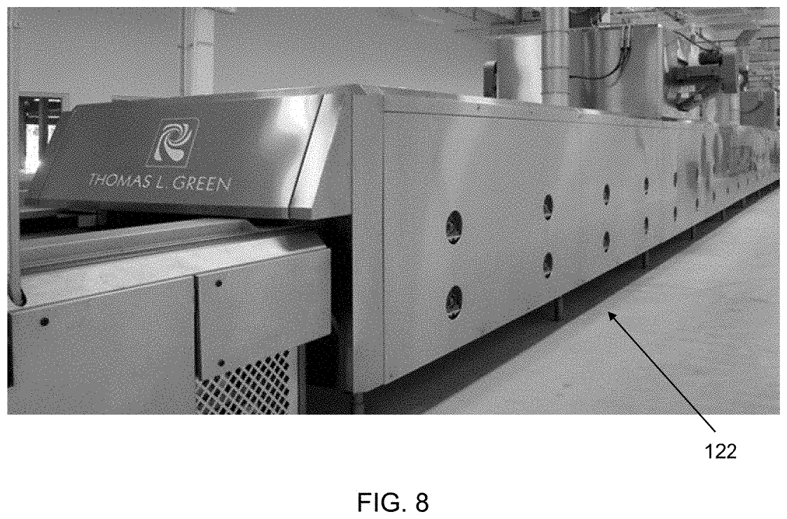

The salted and/or seasoned dough pieces 116 are baked in a multi-phase oven 122 to produce the pretzel crackers 100 in their final form. The oven 122 is depicted in FIGS. 8-11. The baking process is tailored to achieve an optimal combination of crispiness and resistance to checking, without burning the dough pieces 116. The oven 122 can be, for example, a SPECTRUM OVEN® available from Reading Bakery Systems of Robesonia, Pa. The oven 122 is configured to have three zones, each of which subjects the dough pieces 116 to convective heating. The dough pieces 116 undergo a two-phase baking operation in two respective zones of the oven 122; the dough pieces 116 undergo a drying operation in the third zone of the oven.

In the first baking phase in the first zone of the oven 122, the dough pieces 116 are baked, for example, at a temperature range of about 400° F. to about 700° F., for a duration of about 30 seconds to about 300 seconds (step 22). As the baking process is conducted, the dough pieces 116 assume the form of semi-finished pretzel chips 100a.

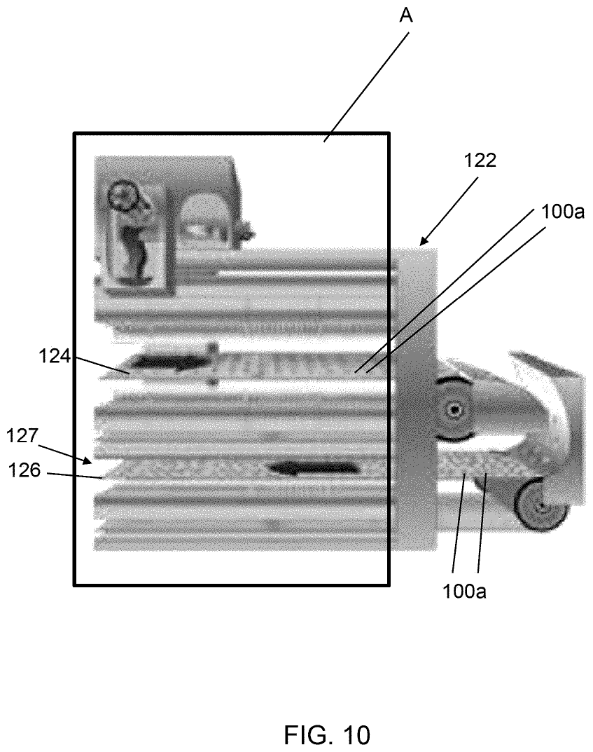

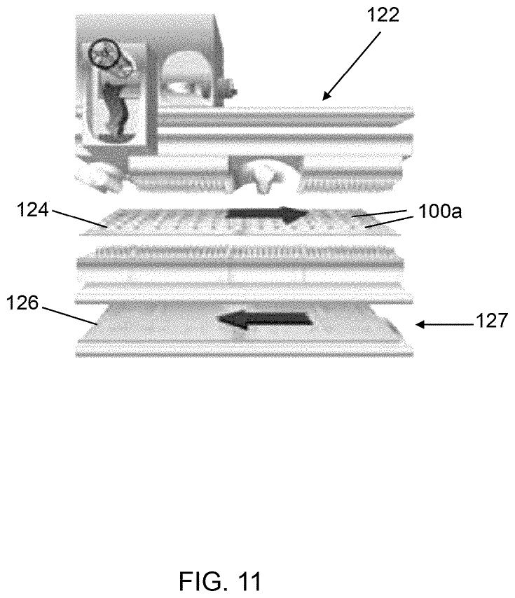

The semi-finished chips 100a are conveyed through the first zone, and to the second zone of the oven 122 by a primary belt 124 shown in FIGS. 10 and 11. The semi-finished chips 100a are baked in the second zone, for example, at a temperature range of about 400° F. to about 700° F., for a duration of about 30 seconds to about 300 seconds (step 24).

After being baked in the second zone of the oven 122, the semi-finished pretzel chips 100a are dropped onto a secondary belt 126, shown in FIGS. 10 and 11. The semi-finished chips 100 are conveyed by the secondary belt 126 to a dryer 127 within the oven 122, where the semi-finished chips 100a undergo a drying process in the dryer 127 (step 28). The drying process reduces core moisture in the crackers 100, providing the finished pretzel chips 100 with resistance to checking and otherwise improving overall product quality. During the drying process, the semi-finished chips can be heated at a temperature range of about 200° F. to about 500° F. for about 2 minutes to about 20 minutes.

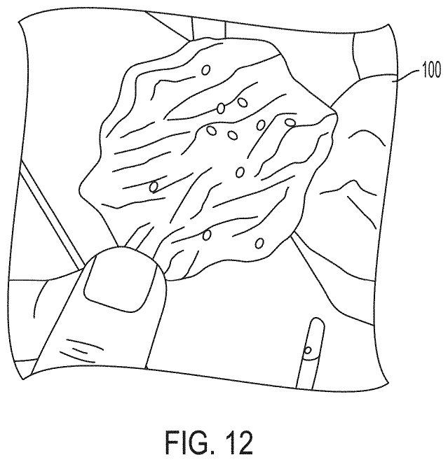

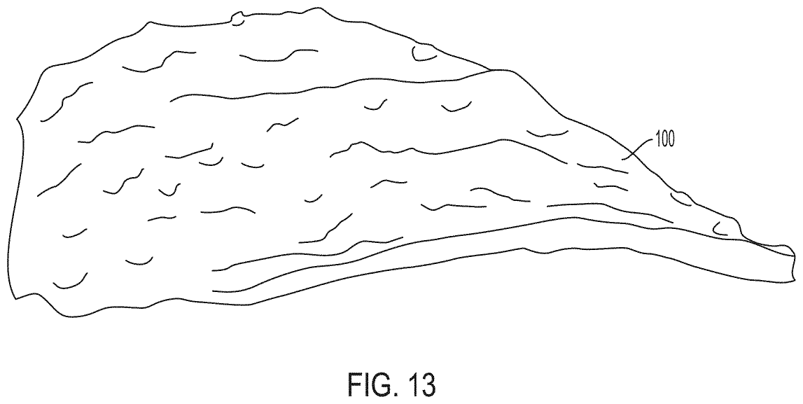

The finished pretzel chips 100 exit the oven 122 after being dried. The pretzel chips 100 have a golden-brown color typical of pretzels, and a thin, wavy appearance as shown in FIGS. 12 and 13. The color of the pretzel chips 100, and their pretzel-like taste, are a result of the immersion of the uncooked dough 116 pieces in the caustic soda bath. Also, as a result of the above-described baking process in combination with the thinness of the dough from which the pieces 116 are formed, the pretzel chips 100 emerge from the baking process with a crispy texture, and without being burned or overcooked. The finished pretzel chips 100 can have a weight of, for example, about 1 gram (about 0.035 ounce) to about 30 grams (about 1.1 ounce).

The process 10 thus combines the dough reduction process normally used on relatively thin crackers with the caustic soda bath normally used in forming pretzels; and further combines a multi-phase/multi-zone baking and drying process that is believed to avoid burning of the relatively thin pretzel dough and checking of the finished pretzel chip product. The finished product has the pH, color, and taste unique to pretzels, and the thinness and crispiness normally associated with crackers and chips. It is believed that such a snack food having the iconic taste and golden-brown appearance of a pretzel, and the crispiness and texture of a thin cracker or chip, will have great appeal to consumers. The pretzel chips can be mass produced on an automated basis, using commercially-available equipment. Also, the pretzel chips can be easily packaged in small individual packets suitable, for example, for vending machines and school lunch boxes; and in larger family-size bags and boxes.

We claim:

1. A process for making a thin foodstuff having pretzel-like qualities, comprising:
providing dough;
forming the dough into a sheet;
reducing a thickness of the dough sheet;
cutting the dough sheet to form dough pieces;
immersing the dough pieces in a caustic soda bath; and
baking the dough pieces.

2. The process of claim 1, wherein baking the pieces of dough comprises baking the pieces of dough in a multi-phase baking operation.

3. The process of claim 2, wherein baking the pieces of dough comprises baking the pieces of dough in multiple baking zones of an oven.

4. The process of claim 3, wherein baking the pieces of dough further comprises:
baking the pieces of dough at a temperature range of about 400° F. to about 700° F., for about 30 seconds to about 300 seconds; and
subsequently baking the pieces of dough at a temperature range of about 400° F. to about 700° F., for about 30 seconds to about 300 seconds.

5. The process of claim 4, wherein:
baking the pieces of dough at a temperature range of about 400° F. to about 700° F., for about 30 seconds to about 300 seconds comprises baking the pieces in a first baking zone of an oven; and
subsequently baking the pieces of dough at a temperature range of about 400° F. to about 700° F., for about 30 seconds to about 300 seconds comprises baking the pieces in a second baking zone of the oven.

6. The process of claim 1, wherein forming the dough into a sheet comprises passing the dough through a dough sheeter.

7. The process of claim 1, wherein reducing a thickness of the dough comprises rolling the dough.

8. The process of claim 7, wherein reducing a thickness of the dough sheet comprises passing the dough sheet through one or more gauging stations.

9. The process of claim 1, wherein reducing a thickness of the dough comprises reducing the thickness of the dough to about 0.5 mm (about 0.020 inch) to about 3.0 mm (about 0.12 inch).

10. The process of claim 1, further comprising drying the baked dough pieces.

11. The process of claim 1, wherein drying the baked dough pieces comprises heating the baked dough pieces at a temperature range of about 200° F. to about 500° F. for about 2 minutes to about 20 minutes.

12. The process of claim 1, wherein the caustic soda bath comprises sodium hydroxide and water.

13. The process of claim 10, wherein the concentration of the sodium hydroxide is about 0.4 percent to about 2.0 percent; the temperature of the caustic soda bath is above 70° F.; and immersing the dough pieces in a caustic soda bath comprises immersing the dough pieces for about 20 seconds.

14. The process of claim 1, wherein providing dough comprises providing dough formed from one of a blend of wheat flour; rice flour; potato flour; potato flakes; cassava flour; oat flour; corn masa; mixtures thereof.

15. The process of claim 1, wherein reducing a thickness of the dough comprises rolling the dough to a thickness of about 0.5 mm (about 0.020 inch) to about 3.0 mm (about 0.12 inch).

16. A foodstuff produced in accordance with the processes of any of claims 1-12.

17. A system for making a thin foodstuff having pretzel-like qualities, comprising:
a sheeter configured to shape dough into a sheet of dough;
one or more gauging stations operatively coupled to the sheeter and configured to reduce a thickness of the sheet of dough;
a die cutter operatively coupled to the one or more gauging stations and configured to cut pieces of dough from the sheet of dough;
a pretzel cooker operatively coupled to the die cutter and configured to immerse the pieces of dough in a bath of caustic soda; and
a multi-zone oven operatively coupled to the pretzel cooker and configured to bake the pieces of dough in a multi-phase baking operation, and further configured to dry the baked pieces of dough.

18. The system of claim 17, wherein the pretzel cooker is configured to immerse the pieces of dough in a bath of sodium hydroxide and water at a temperature range of above 70° F.
